(19) United States
(12) Patent Application Publication
(10) Pub. No.: US 2006/0222328 A1
(43) Pub. Date: Oct. 5, 2006

(54) Digital broadcast playback system, digital broadcast receiving apparatus, and digital broadcast recording and playback apparatus

(76) Inventor: Takashi Akahane, Osaka (JP)

Correspondence Address: MCDERMOTT WILL & EMERY LLP, 600 13TH STREET, N.W., WASHINGTON, DC, 20005-3096, US

(21) Appl. No.: 11/391,312

(22) Filed: Mar. 29, 2006

(30) Foreign Application Priority Data
Mar. 29, 2005 (JP) 2005-094237

(51) Int. Cl. H04N 5/91

(52) U.S. Cl. 386/83

(57) ABSTRACT

A digital broadcast playback system is provided in which, when a program being watched on a digital broadcast receiving apparatus is intermittently unable to be watched, only missed portions can be watched later on a digital broadcast recording and playback apparatus in a simple manner. The digital broadcast receiving apparatus extracts information on a particular program including a broadcasting time from a digital broadcast signal. Further, information on a period during which a user has missed the particular program is added to the extracted information to generate a viewed program table, which is transmitted to the digital broadcast recording and playback apparatus. Based on the viewed program table, the digital broadcast recording and playback apparatus reads video data and audio data for the period missed by the user from a recording medium and plays back video and audio.

### FIELD OF THE INVENTION

The present invention relates to a digital broadcast playback system including a digital broadcast receiving apparatus and a digital broadcast recording and playback apparatus. More specifically, the present invention relates to a digital broadcast playback system in which, when some external cause prevents watching a program on a digital broadcast receiving apparatus, information on the occurrence time and termination time of this unviewable state and information specifying the program are used to watch only a missed portion of the program (referred to as an unviewable portion hereafter) later on a digital broadcast recording and playback apparatus.

### BACKGROUND OF THE INVENTION

As digital broadcasting using satellites or ground waves is becoming popular in these years, receiving digital broadcasts with a portable digital broadcast receiving apparatus is under consideration (see Japanese Laid-Open Patent Publication No. 2002-125181). Use of a portable digital broadcast receiving apparatus will allow a user to watch programs in the user's spare time wherever the user is.

When a portable digital broadcast receiving apparatus is used to receive a digital broadcast outdoors, a difficulty may arise in continuing watching the broadcast due to an external cause. Examples of such a situation include when the user closes the cover of the digital broadcast receiving apparatus while getting on or off a train, when the user enters an area where the digital broadcast cannot be received, such as inside a tunnel, and when the power of a battery used as a power supply for the receiving apparatus decreases. This unviewable state may intermittently occur for several times while one program is being watched.

If a portion of a program is missed on a portable digital broadcast receiving apparatus as in the above cases, it may be possible to record the program in advance on a digital broadcast recording and playback apparatus at home and watch it later. However, in order to watch only the missed portion, the user needs to search for the portion by playing back the program from the beginning. This is a considerable burden, especially if a number of portions are missed.

### BRIEF SUMMARY OF THE INVENTION

It is therefore an object of the present invention to provide a digital broadcast playback system that allows watching only unviewable portions in a simple manner even if an inability to watch the program intermittently occurs.

A digital broadcast playback system of the present invention comprises:

a digital broadcast receiving apparatus that receives a digital broadcast signal to display video on a monitor based on video data contained in the digital broadcast signal and to output audio to a speaker based on audio data contained in the digital broadcast signal; and

a digital broadcast recording and playback apparatus that receives a digital broadcast signal to record video data and audio data contained in the digital broadcast signal onto a recording medium, and reads the video data and the audio data from the recording medium to play back video and audio; wherein
the digital broadcast receiving apparatus extracts information on a particular program including a broadcasting time from the digital broadcast signal, and further generates at least one set of information by adding information on a period during which a user has missed the particular program to the extracted information and transmits the set of information to the digital broadcast recording and playback apparatus; and

based on the set of information transmitted from the digital broadcast receiving apparatus, the digital broadcast recording and playback apparatus reads video data and audio data for the period missed by the user in the particular program from the recording medium and plays back video and audio.

With the digital broadcast playback system of the present invention, unviewable portions can be readily identified in program data even if intermittent unviewable states occur on the digital broadcast receiving apparatus. Therefore, only these portions can be watched later in a simple manner using the digital broadcast recording and playback apparatus.

In the digital broadcast playback system of the present invention, the digital broadcast receiving apparatus preferably sets a period during which the monitor stops displaying video as a period during which the user misses the particular program.

Similarly, the digital broadcast receiving apparatus preferably sets a period during which the video data cannot be decoded as a period during which the user misses the particular program.

Similarly, the digital broadcast receiving apparatus preferably sets a period during which a remaining power of a battery functioning as a driving power supply is below a certain level as a period during which the user misses the particular program.

The present invention also includes the digital broadcast receiving apparatus and the digital broadcast recording and playback apparatus that constitute the digital broadcast playback system.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a block diagram showing a configuration of a digital broadcast receiving apparatus in an embodiment of the present invention;

FIG. 2 is a block diagram showing a configuration of a digital broadcast recording and playback apparatus in the embodiment of the present invention;

FIG. 3 is a conceptual view of a viewed program table in the embodiment;

FIG. 4 is a conceptual view showing an exemplary screen display of the viewed program tables in the embodiment;

FIG. 5 is a conceptual view showing an exemplary display of a program selection screen in the embodiment;

FIG. 6 is a flowchart showing a procedure of generating the viewed program table in the embodiment; and

FIG. 7 is a flowchart showing a procedure beginning with display and transmission of the viewed program table and ending with playback of an unviewable portion in the embodiment.

### DETAILED DESCRIPTION OF THE INVENTION

Now, a digital broadcast playback system in an embodiment of the present invention will be described in detail with reference to the drawings.

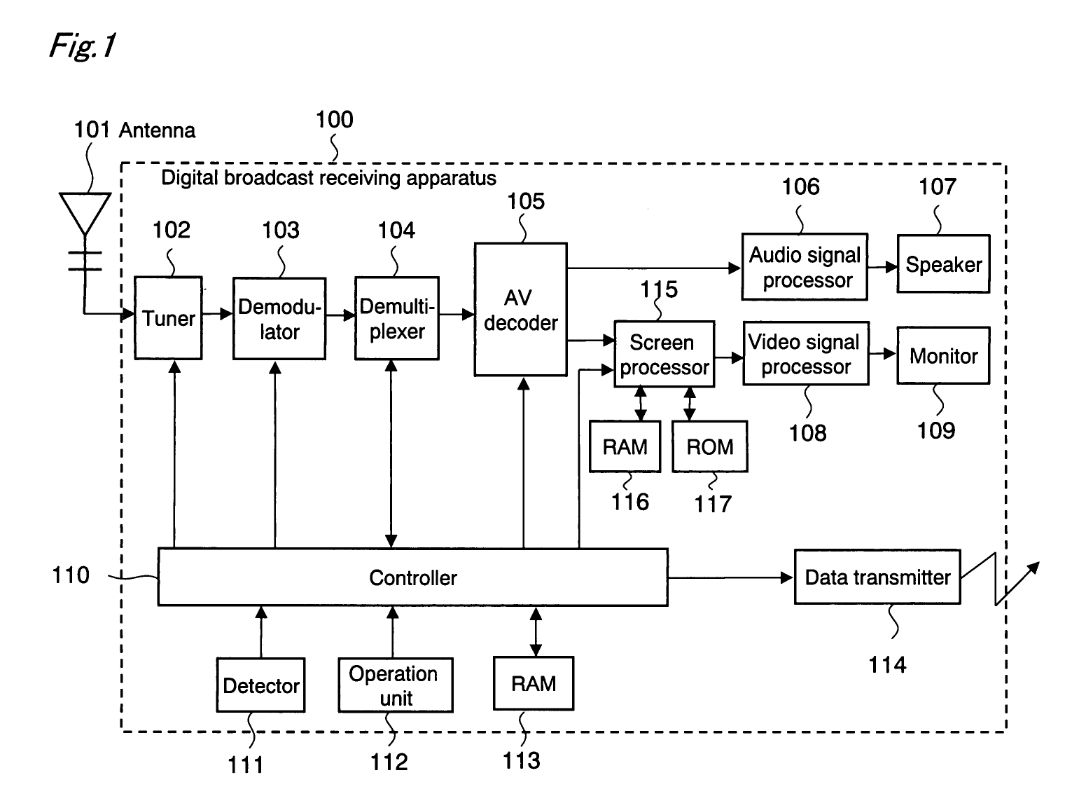

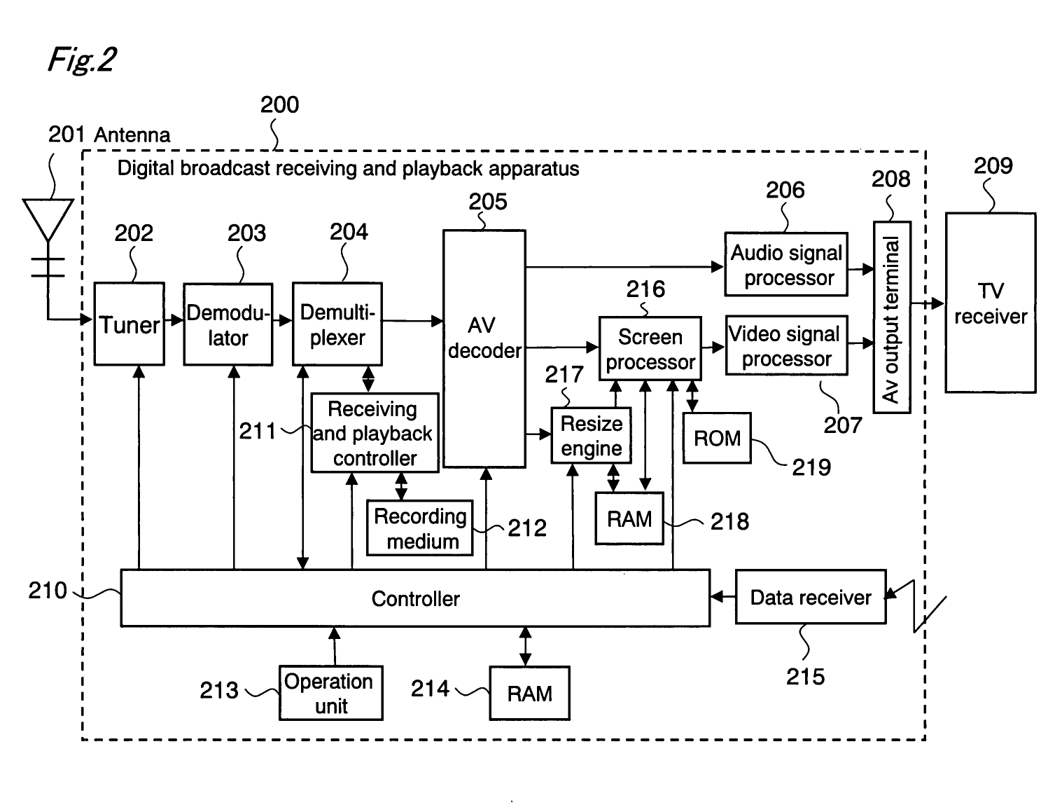

FIGS. 1 and 2 are block diagrams of a digital broadcast receiving apparatus and a digital broadcast recording and playback apparatus, respectively, which constitute the digital broadcast playback system in this embodiment.

First, a configuration of the digital broadcast receiving system 100 will be described with reference to FIG. 1. In FIG. 1, the reference numeral 102 denotes a tuner that extracts a signal of a particular frequency from digital broadcast signals containing visual data and audio data and received at an external antenna 101. The reference numeral 103 denotes a demodulator that demodulates the digital broadcast signal extracted in the tuner 102 and outputs a transport stream (abbreviated as TS hereafter). The reference numeral 104 denotes a demultiplexer that demultiplexes the TS into an MPEG 2 video stream and audio stream, PSI/SI (Program Specific Information/Service Information), which is program-related information, and broadcasting information (the region identifier, service type, broadcasting station type, and service number).

The TS has a plurality of channels multiplexed into it. The processing of selecting a certain channel out of these channels is possible by extracting, from the PSI/SI, data indicating which packet ID has been used for multiplexing the certain channel in the TS. Selection of the TS may also be performed based on the PSI/SI. Furthermore, the SI contains program information (the program title, program start time, program duration, program content information, program genre information, etc.). An EIT (Event Information Table) in the program information allows identifying the program title, broadcasting date and time, program content information, Event_ID, and so on. These information items are stored on RAM (Random Access Memory) 113 described below.

The reference numeral 105 denotes an AV decoder, which includes a video decoder for decoding the video stream and an audio decoder for decoding the audio stream. The video decoder decodes the input coded data and determines a quantization factor and a motion vector to perform processing such as inverse DCT, motion compensation control based on the motion vector, and so on. The audio decoder decodes the input coded data and generates audio data.

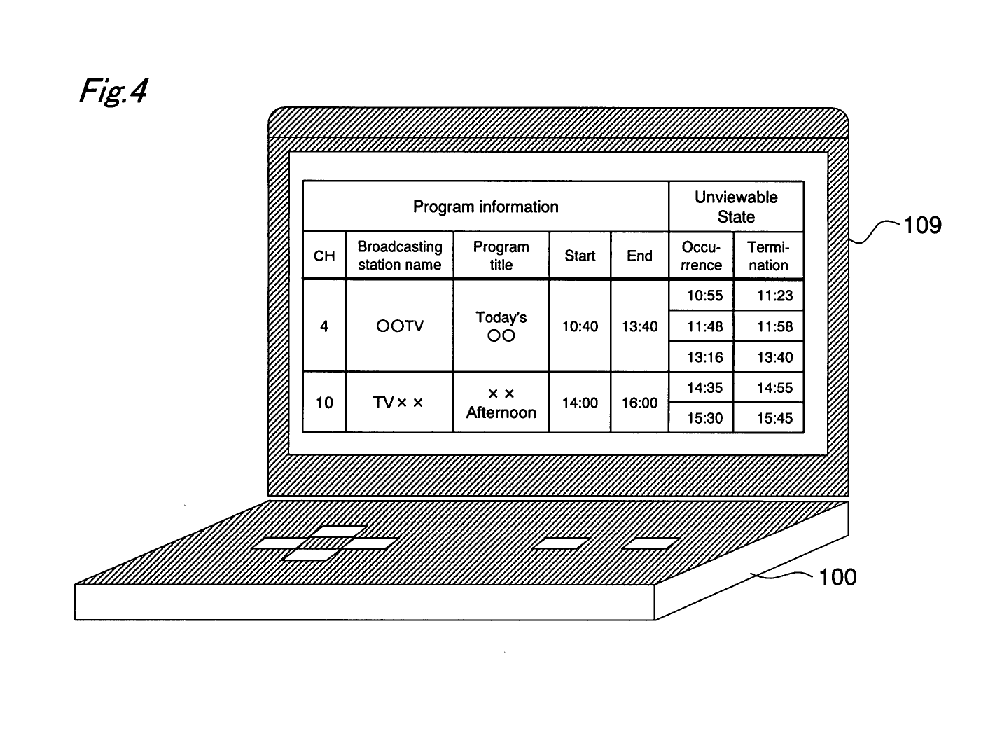

The reference numeral 106 denotes an audio signal processor that performs D/A conversion of the audio data received from the AV decoder 105 and generates an analog audio signal, which is output to a speaker 107. The reference numeral 108 denotes a video signal processor that performs D/A conversion of the video data received from the AV decoder 105 and generates, for example, an NTSC composite signal, which is output to a monitor 109. Since the digital broadcast receiving apparatus used in this embodiment is of a portable type, a cover that doubles as the monitor 109 is attached to the body of the receiving apparatus 100, as shown in FIG. 4 described below. Opening the cover allows a display screen of the monitor 109 to be exposed.

The reference numeral 110 denotes a controller that consists of a CPU (Central Processing Unit). The controller 110 controls components of the digital broadcast receiving apparatus 100 and also generates a viewed program table described below.

The reference numeral 111 denotes a detector, and in this embodiment it consists of a switch attached to the cover of the monitor 109. The detector 111 notifies the controller 110 of the opening or closing of the cover of the monitor 109.

The reference numeral 112 denotes an operation unit that consists of operation buttons including keys such as a channel key, a volume key, direction keys, an enter key, a menu key, a transmission key, and ten keys. The operation unit 112 is coupled to the controller 110, and it inputs commands about watching programs, a command to output the viewed program table to a data transmitter 114 or the monitor 109, and a command to terminate watching the digital broadcast.

The reference numeral 114 denotes a data transmitter that consists of an infrared data communication device. The data transmitter 114 transmits the viewed program table to the digital broadcast recording and playback apparatus shown in FIG. 2 via infrared data communication.

The reference numeral 115 denotes a screen processor that edits a screen so that the viewed program table stored on the RAM 113 is displayed on the monitor 109. The screen processor 115 is provided with RAM 116 used for edition and ROM (Read Only Memory) 117 that stores data on GUI components such as screen frames and icons. The viewed program table edited and converted into bitmap data in the screen processor 115 is transferred to the video signal processor 108, where it is converted into an analog video signal and displayed on the monitor 109. For video data that is output from the AV decoder 105, the screen processor 115 directly transfers the data to the video signal processor 108.

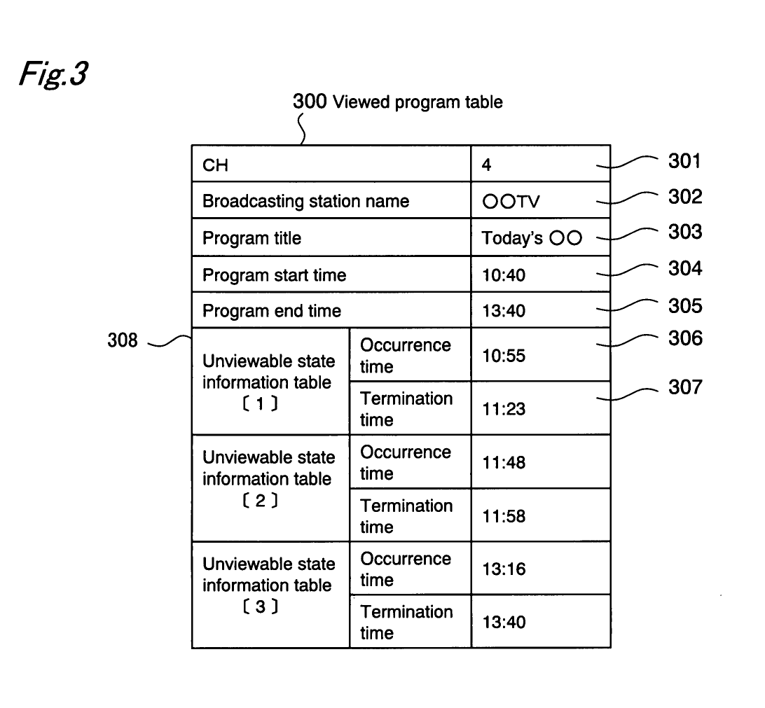

Now, the viewed program table generated in the controller 110 will be described. As shown in FIG. 3, a viewed program table 300 is generated for each viewed program and contains a set of: an unviewable state information table 308 that indicates the period of an unviewable portion (an occurrence time 306 and a termination time 307) that occurred while the program was being watched; and program-related information including a channel number (CH) 301, a broadcasting station name 302, a program title 303, a program start time 304, and a program end time 305. If more than one unviewable states occur while the program is being watched, as many unviewable state information tables 308 as the number of occurrences are generated, as shown in FIG. 3. In this embodiment, when the cover of the monitor 109 is being closed, it is determined that the video display on the monitor 109 is interrupted. Then, the viewed program table 300 is automatically generated and stored on the RAM 113.

When the cover of the monitor 109 is being closed, the controller 110, in response to a notification from the detector 111, generates the unviewable state information table 308 and stores the cover's closing time in the occurrence time 306. Similarly, when the cover of the monitor 109 is being opened, the controller 110 stores the cover's opening time in the termination time 307 of the last generated viewable state information table 308. When a request is received from the operation unit 112 to stop watching, or when a program being watched has ended, the controller 110 generates the viewed program table 300 by combining the program information obtained from the demultiplexer 104 and the unviewable state information tables 308, and writes the viewed program table 300 to the RAM 113.

According to a user command entered on the operation unit 112, the controller 110 reads the viewed program table 300 stored on the RAM 113. The viewed program table 300 is displayed on the monitor 109 and is also output to the data transmitter 114.

FIG. 4 shows an example in which the viewed program tables 300 are displayed in the form of a table on the screen of the monitor 109. In this table, the upper row shows the viewed program table 300 for a program entitled “Today's ◯◯”, and the lower row shows the viewed program table 300 for a program entitled “xx Afternoon”. In each viewed program table 300 are displayed the program-related information shown in FIG. 3 (the CH 301, broadcasting station name 302, program title 303, program start time 304, and program end time 305), as well as the occurrence time 306 and termination time 307 of each unviewable state information table 308.

When the user enters a command on the operation unit 112 for displaying the viewed program tables 300 on the screen of the monitor 109, the controller 110 reads data on the viewed program tables 300 stored on the RAM 113 and transfers the data to the screen processor 115. The screen processor 115 edits a display screen by reading data on GUI components such as a table frame from the ROM 117 and combining the data with the data on the viewed program tables 300. The resulting screen data is converted into bitmap data and transferred to the video signal processor 108. The video signal processor 108 converts the data into an analog video signal, which is displayed on the screen of the monitor 109.

Next, a configuration of the digital broadcast recording and playback apparatus 200 will be described with reference to FIG. 2. Functions of an antenna 201, a tuner 202, a demodulator 203, a demultiplexer 204, an AV decoder 205, an audio signal processor 206, and a video signal processor 207 in FIG. 2 will not be described here, because they are similar to those of the antenna 101, the tuner 102, the demodulator 103, the demultiplexer 104, the AV decoder 105, the audio signal processor 106, and the video signal processor 108 in FIG. 1.

Reference numeral 208 denotes an AV output terminal, which includes right and left audio output terminals and a video output terminal. The AV output terminal 208 is connected to a television (TV) receiver 209, which is an external monitor, via a video/audio code. The TV receiver 209 outputs an audio signal generated in the audio signal processor 206 to a built-in speaker and displays a video signal generated in the video signal processor 207 on the monitor screen.

The reference numeral 210 denotes a controller that consists of a CPU and controls components of the digital broadcast recording and playback apparatus 200. As in the digital broadcast receiving apparatus 100, the PSI/SI data obtained by demultiplexing a TS in the demultiplexer 204 is stored on RAM 214.

The reference numeral 211 denotes a recording and playback controller. Under instructions from the controller 210, the recording and playback controller 211 receives a TS containing user-selected program data from the demultiplexer 204 and writes the TS onto a recording medium 212 such as a hard disk or optical disk. It also reads a TS containing user-selected program data out of TSs recorded on the recording medium 212 and transfers the read TS to the demultiplexer.

The reference numeral 213 denotes an operation unit that consists of operation buttons including keys such as direction keys and an enter key. The operation unit 213 is used by the user in selecting an unviewable portion that the user wants to watch by moving a cursor on the monitor screen on which reduced images (referred to as thumbnails hereafter) for unviewable portions of programs are displayed.

The reference numeral 215 denotes a data receiver that consists of an infrared data communication device. The data receiver 215 performs data communication with the data transmitter 114 shown in FIG. 1 via infrared and receives data on the viewed program tables 300. The received data on the viewed program tables 300 is stored on the RAM 214 by the controller 210.

The controller 210 reads the viewed program tables 300 stored on the RAM 214, and the video data recorded on the recording medium 212. A screen processor 216 edits a screen based on these data items and outputs the screen to the video signal processor 207. The reference numeral 217 denotes a resize engine that uses the video data recorded on the recording medium 212 to generate thumbnails to be incorporated into the display screen. The reference numeral 218 denotes working RAM for the screen processor 216 and the resize engine 217. The reference numeral 219 denotes ROM that stores data on GUI components.

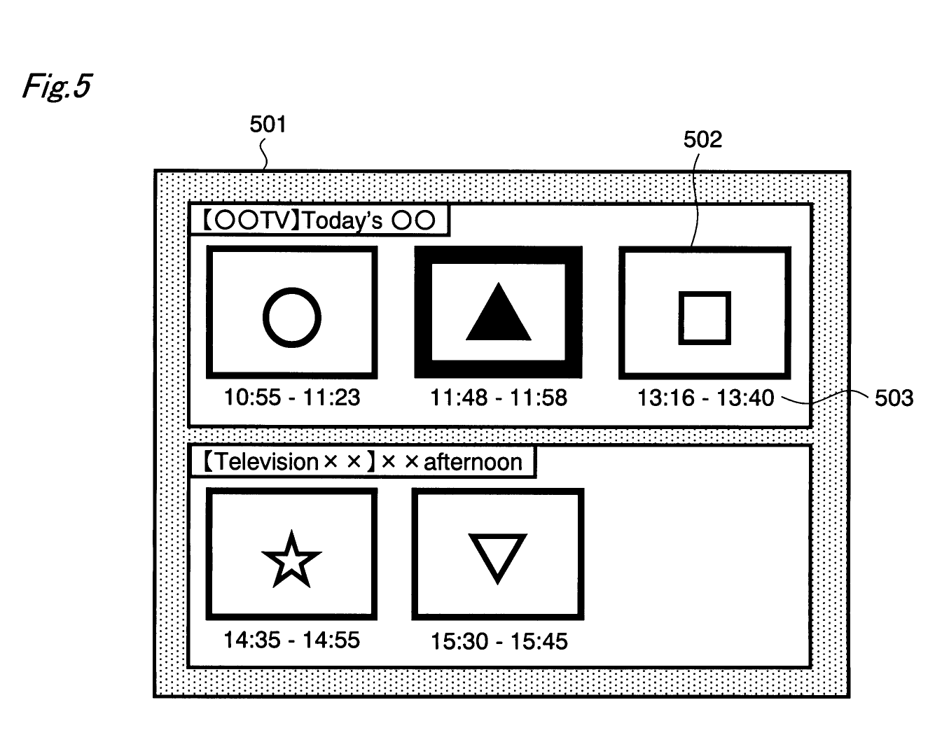

FIG. 5 shows an exemplary screen displayed on the monitor of the TV receiver 209. In the screen 501, the upper row displays information on the viewed program table 300 for a program entitled “Today's ◯◯”, and the lower row displays information on the viewed program table 300 for a program entitled “xx Afternoon”. The three thumbnails 502 in the upper row represent unviewable portions that occurred while the program “Today's ◯◯” was being watched. Time information 503 displayed under each thumbnail indicates the occurrence time 306 and the termination time 307 in the unviewable state information table 308 corresponding to the unviewable portion.

When the user enters a command on the operation unit 210 for rendering the display of FIG. 5 on the screen of the TV receiver 209, the controller 210 reads data on the viewed program tables 300 stored on the RAM 214 and transfers the data to the screen processor 216. The controller 210 also notifies the demultiplexer 204 of the times for which thumbnail display is desired. In response to the notification, the demultiplexer 204 requests the recording and playback controller 211 to read a partial TS. The recording and playback controller 211 reads the requested partial TS from the recording medium 212 and transfers it to the demultiplexer 204. The demultiplexer 204 demultiplexes the partial TS into a video stream and an audio stream. The demultiplexer further searches for frames corresponding to the times for thumbnail display from the video stream and transfers video data for these frames to the AV decoder 205.

The video data for the frames is decoded in the AV decoder 211 and transferred to the resize engine 217, where the size of the video data is reduced to generate thumbnails. The resulting thumbnail data is once stored on the RAM 218 and then transferred to the screen processor 216. The thumbnail data is combined with data such as the occurrence time and termination time of the unviewable portions, a screen frame read from the ROM 219, and so on, and edited as the screen shown in FIG. 5. The screen is further converted into a bitmap and transferred to the video signal processor 207.

Now, operations of the digital broadcast receiving apparatus and the digital broadcast recording and playback apparatus in this embodiment is described with reference to flowcharts.

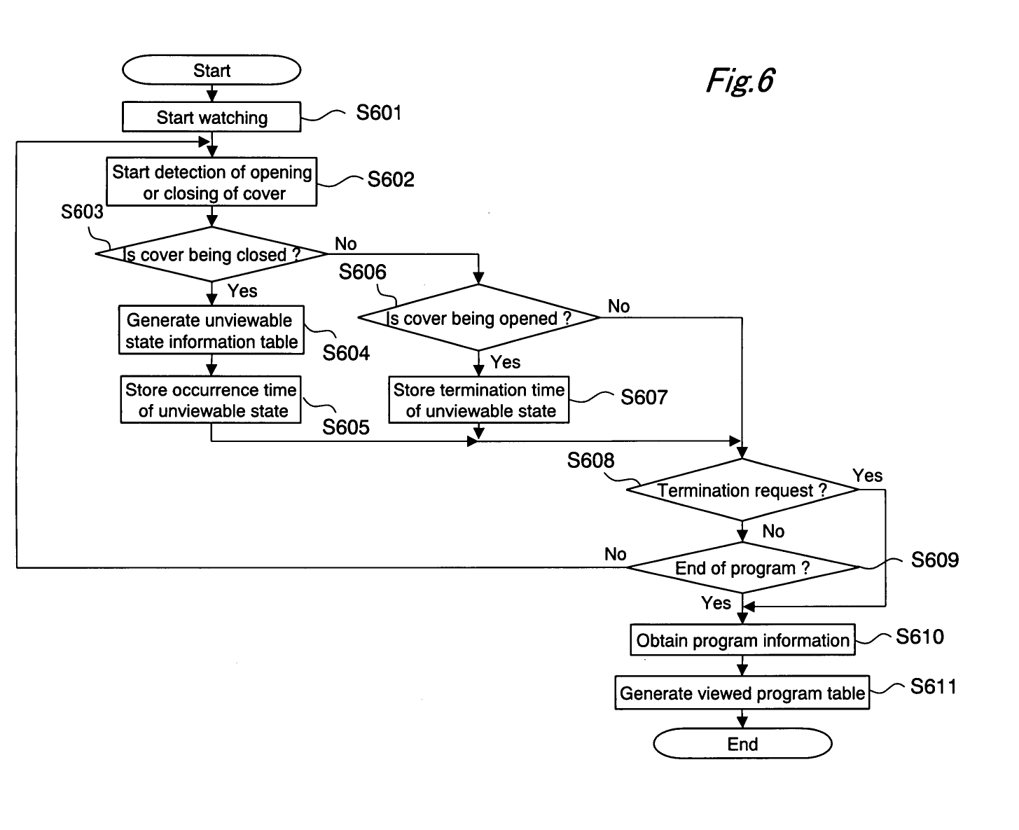

FIG. 6 is a flowchart showing a sequence of operations in the digital broadcast receiving apparatus 100 shown in FIG. 1. The operations include: detecting the opening or closing of the cover of the monitor 109 while a program is being watched; generating, when the video display is interrupted or resumed, the unviewable state information table 308 storing the time of the interruption or resumption; and thereafter generating the viewed program table 300 when the program has ended by combining the unviewable state information table 308 and the program information.

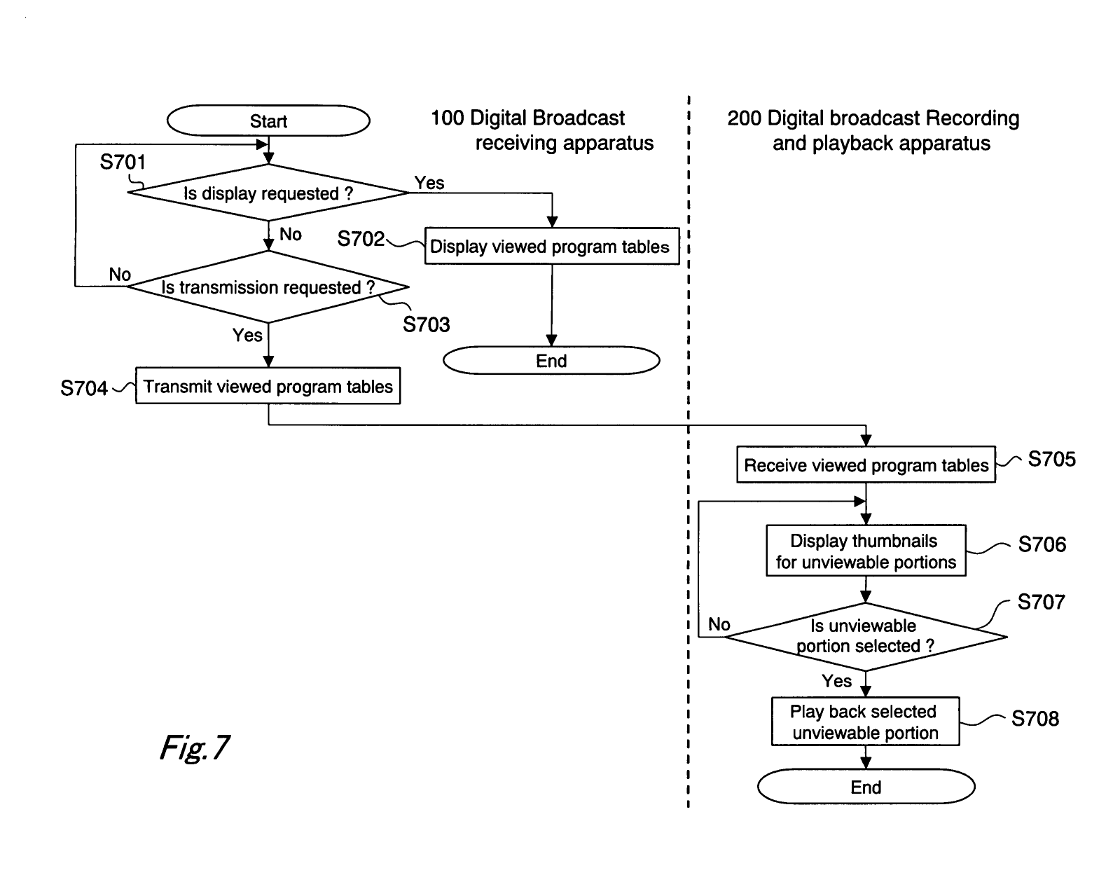

FIG. 7 is a flowchart showing operations in the digital broadcast receiving apparatus 100 and the digital broadcast recording and playback apparatus 200 performed following FIG. 6. That is, it shows a sequence of control operations starting with display or transmission of the viewed program tables 300 in the digital broadcast receiving apparatus 100 and ending with reception of the viewed program tables 300 and playback of an unviewable portion in the digital broadcast recording and playback apparatus 200.

First, using FIG. 6, description will be given of a sequence of operations including detecting the opening or closing of the cover of the monitor 109 while a program is being watched on the digital broadcast receiving apparatus 100 and storing, as the viewed program table 300, the time information on interruption or resumption of the video display and the program information.

The user starts watching a program using the digital broadcast receiving apparatus 100 of a portable type. Naturally, the cover of the monitor 109 is open at this point (step S601). Once the program begins to be watched, the detector 111 starts detection of the opening or closing of the cover of the monitor 109 (S602).

When the user is forced to stop watching the program by an external cause and closes the cover of the monitor 109, the detector 111 notifies the controller 110 of the detection result. The controller 110 receives the detection result and determines that an unviewable state for the program has occurred (S603). The controller 110 generates the unviewable state information table 308 and stores it on the RAM 113 (S604). The controller 110 further stores the occurrence time 306 of the unviewable state in the unviewable state information table 308 (S605).

When the external cause is eliminated and the user opens the cover of the monitor 109 in order to resume watching the program, the detector 111 detects this state (S602), which results in No at step S603. The detector 111 notifies the controller 110 of the detection result. The controller receives the detection result and determines that the unviewable state for the program has terminated and the viewable state has recovered (S606). The controller 110 stores the termination time 307 of the unviewable state in the unviewable state information table 308 (S607).

If the detector 111 does not detect either the opening or closing of the cover of the monitor 109, i.e., if both of steps S603 and S606 result in No, it is assumed that the viewable or unviewable state for the program continues. In that case, no action is taken.

After generating and writing into the unviewable state information table 308, the controller 110 determines whether or not the user requests termination of watching on the operation unit 112. The operation unit 112 notifies the controller 110 whether or not termination of watching is requested (step S608). The controller 110 then obtains the program end time 305 from the demultiplexer 104 and compares it with the current time to determine whether or not the program has ended (S609).

If termination of watching is not requested and the program continues, the controller 110 determines that the user is still watching the program. The process returns to step S602, and again the detection of the opening or closing of the cover of the monitor 109 is started. If more than one unviewable states occur, as many unviewable state information tables 308 as the number of the unviewable portions are generated by repeating steps S602 to S609. This allows the user to obtain information about all unviewable portions that occurred.

If termination of watching is requested or if the program has ended, the controller 110 checks the value of the termination time 307 in the last generated unviewable state information table 308. If the value is void, the value of the program end time 305 is copied and stored therein. The controller 110 obtains the program information (the CH 301, broadcasting station name 302, program title 303, program start time 304, and program end time 305) from the demultiplexer 104 (S610). The controller 110 then combines the program information and the unviewable state information table 308 to make the viewed program table 300 complete, which is stored on the RAM 113 (S611). Any incomplete unviewable state information tables 308 that lack the occurrence time 306 or the termination time 307 are discarded.

If the user watches a plurality of programs, the operations at steps S601 to S611 are performed on each start of watching the programs. Therefore, the viewed program table 300 is automatically stored for each watched program. This allows the user to obtain information about the unviewable portions of all watched programs.

Now, using FIG. 7, description will be given of the control operations, starting with display of the viewed program tables 300 and transmission of the viewed program tables 300 to the digital broadcast recording and playback apparatus 200 performed in the digital broadcast receiving apparatus 100, and ending with thumbnail display and playback of an unviewable portion performed in the digital broadcast recording and playback apparatus 200.

First, in the digital broadcast receiving apparatus 100, the controller 110 determines whether or not the user requests display of the viewed program tables 300 on the operation unit 112 (S701). If display of the viewed program tables 300 is requested, the screen processor 115 edits information on the viewed program tables 300 to create a display screen as shown in FIG. 4 and outputs it to the monitor 109 under instructions from the controller 110 (S702). This allows the user to check the information about the unviewable portions at hand and therefore to find and watch the unviewable portions in a simple manner.

If display of the viewed program tables 300 is not requested, the controller 110 then determines whether or not the user requests transmission of the viewed program tables 300 on the operation unit 112 (S703). If transmission of the viewed program tables 300 is requested, the controller 110 outputs data on the viewed program tables 300 to the data transmitter 114 (S704).

In the digital broadcast recording and playback apparatus 200, the data receiver 215 receives the data on the viewed program tables 300 and stores the data on the RAM 214 (S705). The controller 210 obtains information from the received viewed program tables 300 and determines programs in which unviewable states have occurred as well as unviewable portions. The controller 210 reads the video data on the program stored in advance on the recording medium 212. The screen processor 216 generates a screen with the thumbnails 502 for the unviewable portions displayed thereon as shown in FIG. 5, and outputs the screen to the TV receiver 209 (S706). This allows the user to know the unviewable portions at a glance and eliminates burdensome operations, for example, searching for the unviewable portions by watching the replayed programs.

Once the thumbnails 502 are displayed on the monitor screen of the TV receiver 209, the user uses the operation unit 213 to select an unviewable portion to watch. When the user positions the cursor on the item “Δ” on the screen display shown in FIG. 5 and presses the enter button, the controller 210 is notified that the portion [2] out of the unviewable state information tables 308 has been selected in the viewed program table 300 for the program “Today's ◯◯” (S707). The controller 210 instructs the recording and playback controller 211 to read a TS from the video and audio data on the program “Today's ◯◯” that contains the portion [2] of the unviewable state information tables 308 in the viewed program table 300, from the recording medium 212. The TS is transferred to the demultiplexer 204, where it is demultiplexed into a video stream and an audio stream and transferred to the AV decoder 205. The AV decoder 205 plays back the video and audio and video (S708). This allows the user to watch only unviewable portions later in a simple manner.

In the above embodiment, an aspect has been described in which the user uses the operation unit 213 of the digital broadcast recording and playback apparatus 200 in selecting the unviewable portion on the thumbnail screen. However, in another aspect, the user may use the operation unit 112 of the digital broadcast receiving apparatus 100. In that case, the digital broadcast receiving apparatus 100 acts as a remote control for the digital broadcast recording and playback apparatus 200. That is, the operation unit 112 accepts the user's key operation on the thumbnail screen, such as moving the cursor or selecting an item. The data transmitter 114 sequentially transmits a signal representing the key operation to the digital broadcast recording and playback apparatus 200. The data receiver 215 of the digital broadcast recording and playback apparatus 200 receives the signal representing the key operation and notifies the controller 210 of the key operation. The controller 210 identifies the thumbnail 502 selected by the user based on the key operation and plays back the video and audio for only the unviewable portion corresponding to the selected thumbnail 502. This allows the user to watch unviewable portions of the program later in a simple manner without handling a plurality of devices but only with an operation on the digital broadcast receiving apparatus 100.

While the above embodiment has been described with regard to the opening and closing of the cover of the monitor 109, the present invention is not limited to this. Rather, an aspect may be employed in which the AV decoder 105 detects the inability of decoding the program being watched and determines that the reception state of the broadcast signal has changed. In that case, the controller 110 automatically generates the viewed program table 300 in the event of inability of decoding the program being watched. This allows the user to watch only unviewable portions later in a simple manner even if, for example, the user enters an underground mall and is disabled from watching the program due to a bad reception condition.

Alternatively, if the digital broadcast receiving apparatus 100 is battery-driven, an aspect may be employed in which the controller 110 detects that the remaining battery power is below a certain level and determines that the reception state for the broadcast signal and the display state have changed. Again, the controller 110 automatically generates the viewed program table 300. This allows the user to watch only unviewable portions of the program later in a simple manner even if the remaining battery power decreases and the difficulty in watching the program arises. These detection methods may also be used in combination.

In the above embodiment, an aspect has been described in which the infrared data communication device is used for the data transmitter 114 and the data receiver 215. However, the present invention is not limited to this. For example, use of a wireless LAN communication device (802.11b/g/a) allows expansion of the communication range. Use of a Bluetooth communication device allows automatic synchronization of data transmission and reception between the digital broadcast receiving apparatus 100 and the digital broadcast recording and playback apparatus 200, thereby saving the necessity of making a transmission request by the user. Communication over the Internet may also be employed.

With the digital broadcast playback system according to the present invention, only unviewable potions can be identified in an entire program even if intermittent unviewable states occur while the program is being watched. In addition, the unviewable portions can be watched later in a simple manner. Therefore, the system is useful for applications such as one involving the combination of a portable digital broadcast receiving apparatus and a fixed media server.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A digital broadcast playback system comprising:
a digital broadcast receiving apparatus that receives a digital broadcast signal to display video on a monitor based on video data contained in the digital broadcast signal and to output audio to a speaker based on audio data contained in the digital broadcast signal; and
a digital broadcast recording and playback apparatus that receives a digital broadcast signal to record video data and audio data contained in the digital broadcast signal onto a recording medium, and reads the video data and the audio data from the recording medium to play back video and audio; wherein
the digital broadcast receiving apparatus extracts information on a particular program including a broadcasting time from the digital broadcast signal, and further generates at least one set of information by adding information on a period during which a user has missed the particular program to the extracted information and transmits the set of information to the digital broadcast recording and playback apparatus; and
based on the set of information transmitted from the digital broadcast receiving apparatus, the digital broadcast recording and playback apparatus reads video data and audio data for the period missed by the user in the particular program from the recording medium and plays back video and audio.

2. The digital broadcast playback system according to claim 1, wherein the digital broadcast receiving apparatus sets a period during which the monitor stops displaying video as a period during which the user misses the particular program.

3. The digital broadcast playback system according to claim 1, wherein the digital broadcast receiving apparatus sets a period during which the video data cannot be decoded as a period during which the user misses the particular program.

4. The digital broadcast playback system according to claim 1, wherein the digital broadcast receiving apparatus sets a period during which a remaining power of a battery functioning as a driving power supply is below a certain level as a period during which the user misses the particular program.

5. A digital broadcast receiving apparatus comprising:
a tuner that extracts a signal of a particular frequency from digital broadcast signals received at an antenna;
a demodulator that demodulates the signal of the particular frequency extracted in the tuner and outputs a stream containing video data and audio data;
a demultiplexer that demultiplexes the stream into a video stream and an audio stream as well as program-related information;
an AV decoder that decodes the video stream and the audio stream demultiplexed into in the demultiplexer and generates a digital video signal and a digital audio signal;
a video signal processor that converts the digital video signal generated in the AV decoder into an analog video signal and outputs the signal to a monitor;
an audio signal processor that converts the digital audio signal generated in the AV decoder into an analog audio signal and outputs the signal to a speaker;
a memory that stores the program-related information demultiplexed into in the demultiplexer;
a detector that detects a user's inability to watch video played on the monitor;
a data transmitter that transmits data to an external apparatus: and
a controller that controls operation of each of the components; wherein
the controller extracts information on a particular program including a broadcasting time from the program-related information stored on the memory, and further generates at least one set of information by adding information on a period during which the user has missed the particular program to the extracted information based on an output of the detector and transmits the set of information to a digital broadcast recording and playback apparatus through the data transmitter.

6. The digital broadcast receiving apparatus according to claim 5, wherein the detector detects that the monitor stops displaying video.

7. The digital broadcast receiving apparatus according to claim 5, wherein the detector detects that the AV decoder cannot decode the video stream.

8. The digital broadcast receiving apparatus according to claim 5, wherein the detector detects that the remaining power of a battery functioning as a driving power supply is below a certain level.

9. The digital broadcast receiving apparatus according to claim 5 further comprising a screen processor that edits a display screen for the monitor based on the set of information.

10. A digital broadcast recording and playback apparatus comprising:
a tuner that extracts a signal of a particular frequency from digital broadcast signals received at an antenna;
a demodulator that demodulates the signal of the particular frequency extracted in the tuner and outputs a stream containing video data and audio data;
a demultiplexer that demultiplexes the stream into a video stream and an audio stream as well as program-related information;
a recording and playback controller that records the stream containing video data and audio data output from the demodulator onto a recording medium;
an AV decoder that decodes the video stream and the audio stream demultiplexed into in the demultiplexer and generates a digital video signal and a digital audio signal;
a video signal processor that converts the digital video signal generated in the AV decoder into an analog video signal and outputs the signal to a monitor;
an audio signal processor that converts the digital audio signal generated in the AV decoder into an analog audio signal and outputs the signal to a speaker;
a data receiver that receives data from an external apparatus;
a memory that stores the data received in the data receiver; and
a controller that controls each of the components; wherein
the data receiver receives, from a digital broadcast receiving apparatus, at least one set of information containing information on a particular program including a broadcasting time and information on a period during which a user has missed the particular program; and
the controller uses the set of information received in the data receiver to read video data and audio data for the period missed by the user in the particular program from the recording medium, and outputs the video data and the audio data to the AV decoder.

11. The digital broadcast recording and playback apparatus according to claim 10 further comprising:
a resize engine that reads a frame of video data corresponding to each period missed by the user in the particular program from the stream recorded on the recording medium and generates a reduced image; and
a screen processor that edits a display screen for the monitor by arranging on the screen a plurality of reduced images generated in the resize engine.
